(19) United States
(12) Patent Application Publication
(10) Pub. No.: US 2008/0282904 A1
(43) Pub. Date: Nov. 20, 2008

(54) Automatic or Semi-Automatic Turning Method and Device

(76) Inventor: Xiaoyong Liu, Guangdong (CN)

Correspondence Address: KENING LI;PINSENT MASONS, c/o BAKER DONELSON BEARMAN CALDWELL& BERKOWITZ, PC, 555 ELEVENTH STREET, NW, SIXTH FLOOR, WASHINGTON, DC, 20004, US

(21) Appl. No.: 11/813,718

(22) PCT Filed: Jan. 9, 2005
(86) PCT No.: PCT/CN06/00026

§ 371 Date: Jan. 22, 2008

(30) Foreign Application Priority Data
Jan. 12, 2005 (CN) 200510032812.5

(51) Int. Cl. A47J 43/04

(52) U.S. Cl. 99/352; 99/337; 99/338

(57) ABSTRACT

The present invention provides an automatic or semi-automatic method for turning over and/or stirring the cooking material of a cooking container in an automatic or semi-automatic cooking utensil. The method can comprise the following steps: (1) limiting the cooking material in a cooking container within a desired area in its main direction or all directions by a limiting means, and (2) turning over or stirring the cooking material limited in the desired area of the cooking container through the movement of the cooking container and/or by a turning-over/stirring means. The present invention also provides a turning-over/stirring device with a limiting means and an automatic or semi-automatic cooking utensil with such a turning-over/stirring device.

### FIELD OF THE PRESENT INVENTION

The present invention relates to an automatic or semi-automatic method for turning over or stirring the cooking material in a cooking container and the device which can be used to implement this method. More particularly, the present invention relates to an automatic or semi-automatic method for turning over or stirring the cooking material in a cooking container during a cooking process, an automatic or semi-automatic turning-over device which can be used to implement the method and an automatic or semi-automatic cooking utensil or cooking machine equipped with the turning-over/stirring device.

### BACKGROUND OF THE PRESENT INVENTION

Turning over the cooking material in a cooking container or a cooker automatically or semi-automatically is one of the important preconditions in achieving intelligent automatic or semi-automatic cooking. A problem may be occurred when turning over or stirring the cooking material in a cooking container or a pan, especially in high speed, that the cooking material will sometimes be away from an appropriate area, i.e. a desired area, when a turning-over means or a stirring means starts to work or when the cooking container or the pan starts to move for shaking, turning over and/or stirring. That means it is possible that all or part of the cooking material is in an unappropriate area, i.e. an undesired area. The so-called appropriate area is the place where the cooking material can be heated, stirred and/or turned over correctly, effectively and/or evenly according to the requirements of a cooking process. Usually the appropriate area locates within an inner area around the heated center of a cooking container and should always be smaller than the whole inner area of a cooking container, for instance, a Chinese fry-pan. As a specific example the appropriate area extends to the whole inner area of a cooking container. The so-called unappropriate area is the place where the cooking material is difficult to or even can not be turned over or stirred by a turning-over means or a stirring means evenly and effectively, the place where the cooking material is difficult to or even can not go back to the appropriate area, the place where the cooking material is difficult to or even can not be gathered to the desired area in a cooking container, the place where the cooking material is difficult to or even can not be heated evenly and effectively, and/or the place where it is not advantageous to a cooking process. For example, such an unappropriate area could be a blind area where a turning-over means or a stirring means can not reach, an area where a good turning-over effect can not be obtained although a turning-over means or a stirring means can reach there, an area which is beyond the turning-over/stirring range or even out of a cooking container or a pan, or an area where the control system of a cooking utensil or a cooking machine is difficult to or can not detect the existence of the cooking material although it is in the area where it could be turned over or stirred but it fails to be turned over or stirred. When the appropriate area extends to the whole inner area of a cooking container, then the unappropriate area is the area which is out of the cooking container. The quality of the dish can be influenced seriously under the foresaid circumstances.

Chinese Application No. 90102836.3, which was deemed to be withdrawn, discloses a servo mechanical device in a cooking utensil, in which two shovel-arms are symmetrically or separately used to replace different tools to implement the actions of stir-frying, mixing, shoveling, etc. The device of this patent can perform several stirring actions. However, during a stirring process, some or all of the cooking material may be pushed to an unappropriate area where this part of the cooking material cannot be pushed back to an appropriate area at all by this device itself.

Chinese Application No. 92101587.9, which was also deemed to be withdrawn, discloses a cooking utensil to turn over the cooking material by overturning its pan. However, when overturning the pan some or all of the cooking material in it could fall to an unappropriate area where this part of the cooking material can not be taken back to an appropriate area by this utensil itself.

### SUMMARY OF THE PRESENT INVENTION

An object of the present invention is to provide an automatic or semi-automatic method which can be used to turn over or stir the cooking material in a cooking container, in which the turned-over or stirred material is limited within an appropriate area in order to have it turned over or stirred effectively and heated evenly according to the requirements of a cooking process.

Another object of the present invention is to provide a turning-over/stirring device in which the above method can be implemented. The turning-over/stirring device can be used in various cooking equipments, especially in those automatic or semi-automatic cooking utensils for preparing Chinese dishes and western dishes. It can not only perform turning over actions or stirring actions automatically or semi-automatically, but also perform these actions with high efficiency, perfect effect and high accuracy which a human chef can never reach.

On the one hand, the present invention provides an automatic or semi-automatic method for turning over or stirring the cooking material in a cooking container, comprising the following steps:

(1) limiting the cooking material in a cooking container, for instance a pot, a pan or a wok, within a desired area in its main directions or all directions by a limiting means, and

(2) turning over or stirring the cooking material limited in the desired area of the cooking container through the movement of the cooking container and/or by a turning-over/stirring means.

The above desired area is the appropriate area where the cooking material should be in the cooking container according to the characteristic of a cooking utensil, the requirements of a cooking process and the demand of a user. The appropriate area, which is included in the above desired area, is the place where the cooking material can be heated, stirred and/or turned over correctly, effectively and/or evenly according to the requirements of a cooking process. Usually the appropriate area locates within an inner area around the heated center of a cooking container and should always be smaller than the whole inner area of a cooking container. Take a Chinese fry-pan as an instance. The certain area around the center of the Chinese fry-pan is the appropriate area if its heat source locates at its bottom center, for example the area within a circle with the center of this fry-pan as its center and with the diameter of 5 cm to 15 cm, or a smaller area. In the other area the temperature of the fry-pan can decrease rapidly, and thus the other area can become unappropriate area. Of course the appropriate area can also be the whole inner area of a cooking container, for example, when using a smaller pan, when using a pan with a special shape or configuration, when turning a pan at a large angle such as overturning at 180° or 360°, and when heating the whole body of a pan evenly. The unappropriate area is the place where the cooking material is difficult to or even can not be turned over or stirred by a turning-over means or a stirring means evenly and effectively, the place where the cooking material is difficult to or even can not go back to the appropriate area, the place where the cooking material is difficult to or even can not be gathered to the desired area in a cooking container, the place where the cooking material is difficult to or even can not be heated evenly and effectively, and/or the place where it is not advantageous to a cooking process. For example, such an unappropriate area could be a blind area where a turning-over means or a stirring means can not reach, an area where a good turning-over effect can not be obtained although a turning-over means or a stirring means can reach there, an area which is beyond the turning-over/stirring range or even out of a cooking container or a pan, or an area where the control system of a cooking utensil or a cooking machine is difficult to or can not detect the existence of the cooking material although it is in the area where it could be turned over or stirred but it fails to be turned over or stirred. When the appropriate area extends to the whole inner area of a cooking container then the unappropriate area is the area which is out of the cooking container.

The present turning-over/stirring method can further comprise the step of moving the limiting means to/from a working position, and/or moving the cooking container to/from the limiting means in order to perform other actions of a cooking utensil.

The present turning-over/stirring method can further comprise the step of moving the turning-over/stirring means to/from a working position, and/or moving the cooking container to/from the turning-over/stirring means in order to perform other actions of a cooking utensil.

On the other hand, the present invention further provides a turning-over/stirring device which can be used for implementing the above turning-over/stirring method, comprising a cooking container, a limiting means and a turning-over/stirring means. The limiting means has a planar and/or curved surface and is set on proper positions at main or all motion directions to prevent the cooking materials from moving or being added to wrong positions by limiting the movement of the cooking material. The turning-over/stirring means can be a shovel, a ladle, a fork, a stick, a comb, a stirrer with a planar or curvy surface, a stirrer which can rotate, make linear movement or make curvilinear movement, a motion mechanism of the cooking container for turning over or stirring the cooking material in it, and the combination thereof.

The size of the limiting means will be approximately the same as or exceed slightly that of the appropriate area. Usually the limiting means is smaller than the cooking container. At extreme circumstances it can cover the whole cooking container. Its overall shape can be a cover, preferably with one or more holes to discharge rapidly most of the steam produced when cooking, or a ring, etc. The shape of its bottom edge can match with the shape of the inner surface of the cooking container. The limiting means can be integrated with the cooking container as a whole, or it can be a separate unit which is independent on the cooking container. The limiting means can be contacted intimately with the cooking container by its gravity force, the magnetic force produced by the magnet mounted on the limiting means or the cooking container, the pressure force produced by a motion mechanism, the clamping force produced by a clamping or locking mechanism, etc.

The turning-over/stirring means and/or its driving mechanism can be integrated with the limiting means as a whole, or they are separate units. The limiting means and the turning-over/stirring means can be installed on a motion mechanism separately or together which is driven by an electric and/or magnetic, a pneumatic, a hydraulic, and/or a mechanical driving mechanism for moving to/from a working position when required. They can share or have their own transmission mechanism.

A rigid connection, a flexible connection or a detachable connection can exist between the limiting means, the turning-over/stirring means, the above driving mechanism, the above transmission mechanism and/or other parts of the cooking utensil. With the flexible connection or the detachable connection, the limiting means and the turning-over/stirring means can move with the cooking container in a better mode.

The turning-over/stirring device of the present invention can further comprise a control system which can be independent on or integrated with the general control system of the cooking utensil. Through the driving mechanism and/or the transmission mechanism, the control system can directly drive and/or control the movement of one, several, or all of the members of the turning-over/stirring device, or it can send a prompting information in audio, video, light, electric, or literal through a prompting means. Then according to the prompting information, the operator will drive or control the movement of one, several, or all of the members of the turning-over/stirring device through the driving mechanism, the transmission mechanism, and/or a human hand.

As a further object, the present invention provides an automatic or semi-automatic cooking utensil which comprises a feeding system, a control system, a heating system, a cooking container such as a pan, a pot or a wok, etc. The feature of the present cooking utensil is that it comprises a turning-over/stirring device with a limiting means. The limiting means has a planar and/or curved surface and is set on the proper position at main or all motion directions to prevent the cooking materials from moving or being fed to wrong positions by limiting the movement of the cooking material.

Compared with the technology in the prior art, due to the utilization of a limiting means, the present method for turning over or stirring the cooking material in a cooking container can prevent the cooking material from moving to an unappropriate area even for a 180°-360° overturning at high speed. Even with a relatively simple turning-over/stirring device, a perfect turning-over/stirring effect can be obtained by the present invention which can never be reached in the prior art. The turning-over/stirring device of the present invention can perform an automatic or semi-automatic turning-over/stirring action with unbelievable simplicity and efficiency with the labor intensity lowered greatly in cooking. Therefore, the present turning-over/stirring method and the device therewith are particularly suitable for an automatic or semi-automatic cooking process and an automatic or semi-automatic cooking utensil.

These and other advantages of the present invention will become apparent to those skilled in the art upon reading and understanding the following detailed description with reference to the accompanying figures.

### BRIEF DESCRIPTION OF THE DRAWINGS

FIG. 1 is the schematic view of an automatic cooking machine with the turning-over/stirring device of the present invention which can be used to implement the turning-over/stirring method of the present invention.

FIG. 2 is the schematic view of the turning-over/stirring device in one embodiment of the present invention.

FIG. 3 is the schematic view of the turning-over/stirring device in another embodiment of the present invention.

FIG. 4 is the schematic view of the turning-over/stirring device in further another embodiment of the present invention.

FIG. 5 is the schematic view when the limiting range of the turning-over/stirring device covers the whole range of the cooking container in further another embodiment of the present invention.

FIG. 6 is the schematic view when the limiting means of the device in FIG. 5 is contacted with the cooking container.

FIG. 7 is the schematic view when the limiting range of the turning-over/stirring device covers the whole range of the cooking container in further another embodiment of the present invention.

FIG. 8 is the schematic view of the turning-over/stirring device in further another embodiment of the present invention.

FIG. 9 is the view of interior members of the device in FIG. 8.

### DETAILED DESCRIPTION OF THE PRESENT INVENTION

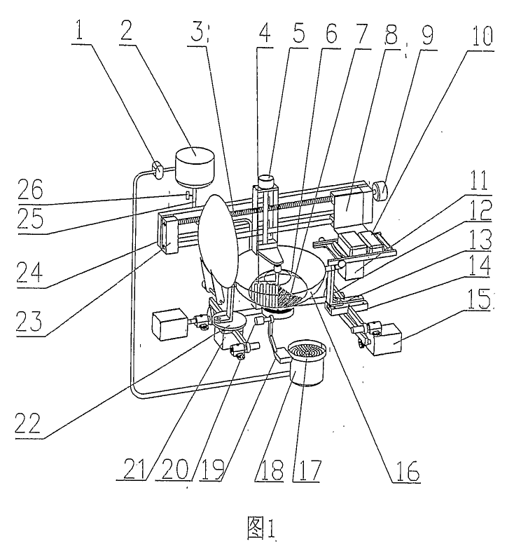

FIG. 1 shows an automatic cooking machine with the turning-over/stirring device of the present invention which can be used to implement the turning-over/stirring method of the present invention. Reference number 16 is a pot. 17-20 constitute an oil-rinsing system in which 17 is a filter, 18 is a container, 19 is a movement mechanism to move the filter and 20 is a motor. 21, 22, and 12-14 form a crank-rocker mechanism to drive the pot to shake. 11 is an electric driving motor and a motor reducer to drive the pot to rotate. 15 is an electric driving motor and a motor reducer to drive the pot to make translational movement. 8-9 are a material-feeding mechanism, and 10 is a package of cooking material. 1, 2, 25 and 26 are an oil recycling-feeding system in which 1 is a pump, 2 is a container, 25 is a pipeline to the pot and 26 is a valve. 4-7 are a turning-over/stirring device in which 6 is a limiting means, 4 is a comb-shaped turning-over/stirring means and 7 is a shovel-shaped turning-over/stirring means. 4 and 7 are installed on a same rotation shaft. The electric motor 5 drives the turning-over/stirring device to lift. 23, 24 and 3 are a screw mechanism to drive the turning-over/stirring device and the material-feeding mechanism to make translational movement.

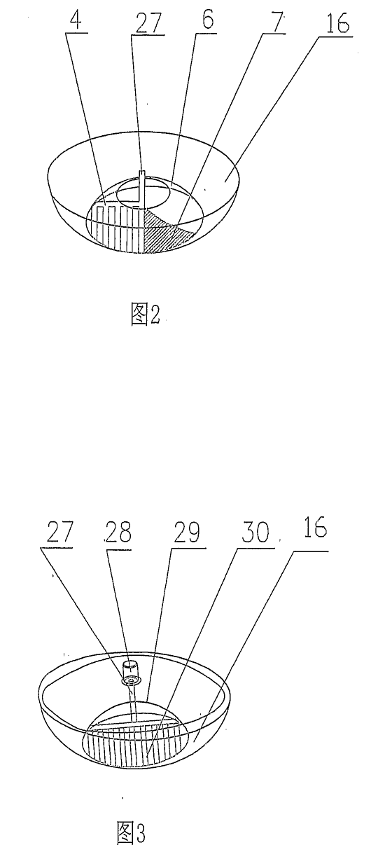

FIG. 2 shows the turning-over/stirring device in one embodiment of the present invention in which 16 is a pot. 6 is a limiting means with a ring shape, whose hemline approximates that of the inner surface of the pot and can be contacted intimately with the inner surface of the pot when put down. A comb-like turning-over/stirring means 4 and a shovel-like turning-over/stirring means 7 are installed in combination on a rotation shaft 27 which is driven by a driving-transmission mechanism to drive 4 and 7 to rotate. The limiting means 6, the turning-over/stirring means 4 and 7, and 27 can move up and down together or separately driven by the driving-transmission mechanism. The connection between 27 and the driving-transmission mechanism can be a flexible connection. For example, 4 and 7 can be designed to retract inward when the shaft 27 lifts from the pot or to stretch outward when the shaft 27 lowers down to the pot. In that example the turning-over/stirring means 4 and 7 can pass through the centric hole of the limiting means 6 when they lift or lower independently. The limiting means and the turning-over/stirring means are on the upper left of the pot when not used, and when being used they will make translational movement to the upper of the appropriate area of the pot and then lower to make the bottom edge of the limiting means to contact with the inner surface of the pot. The turning-over/stirring means locates between the limiting means and the inner surface of the pot, the cooking material is enclosed in the appropriate area by the limiting means, and the turning-over/stirring means stirs the cooking material which is enclosed between the limiting means and the pot. When the pot makes shaking movement and the turning-over movement, the limiting means and the turning-over/stirring means can move with the pot together or separately due to their flexible connection with the driving-transmission mechanism such as a driving gear. When it is necessary to feed the cooking material into the appropriate area, the material-feeding mechanism moves to the upper of the limiting means and adds the cooking material into the appropriate area of the pot through the centric hole of the limiting means.

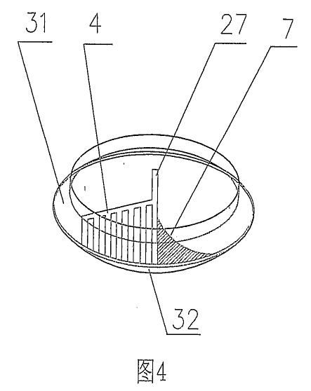

Please refer to FIG. 3. It shows another embodiment of the present invention. The form and the operating manner of this embodiment are similar to those of the first embodiment. 29 is a cover-like limiting means. 30 is a comb-like turning-over/stirring means located between the limiting means 29 and the inner surface of the pot. Rotation shaft 27 passes through the centric hole of the limiting means 29, and an electric motor 28 drives the rotation shaft 27 to rotate which in turn drives the turning-over/stirring means 30 to rotate.

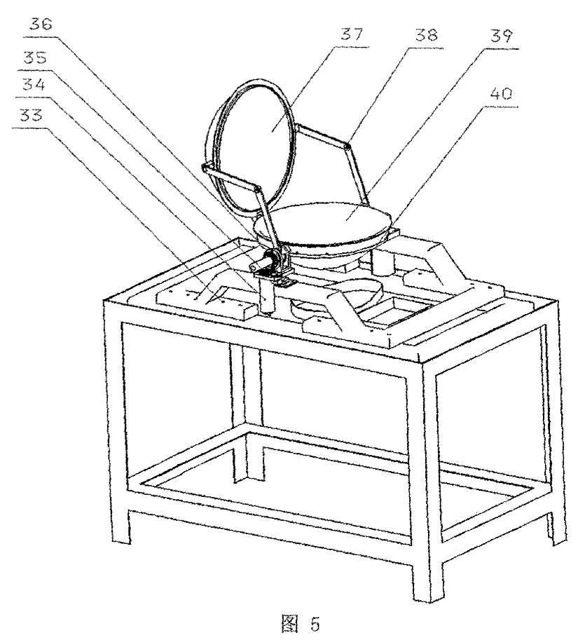

Please refer to FIG. 4. It shows further another embodiment of the present invention in which 31 is a limiting means integrated with a pot 32, and 4, 7 and 27 constitute a turning-over/stirring means.

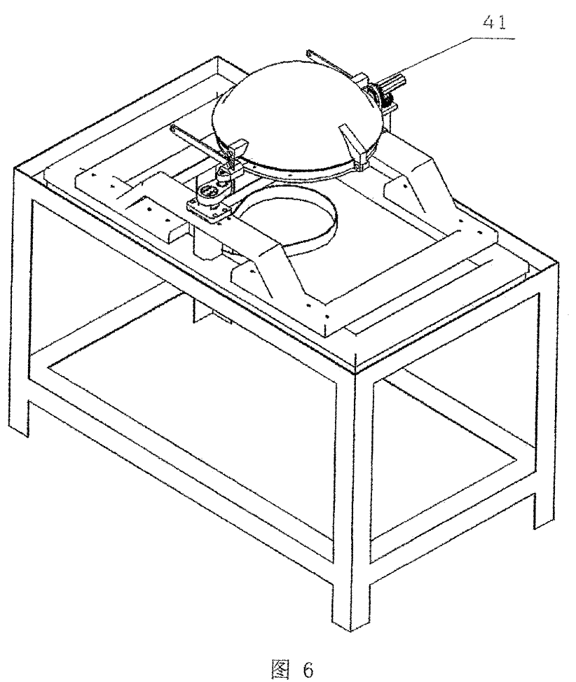

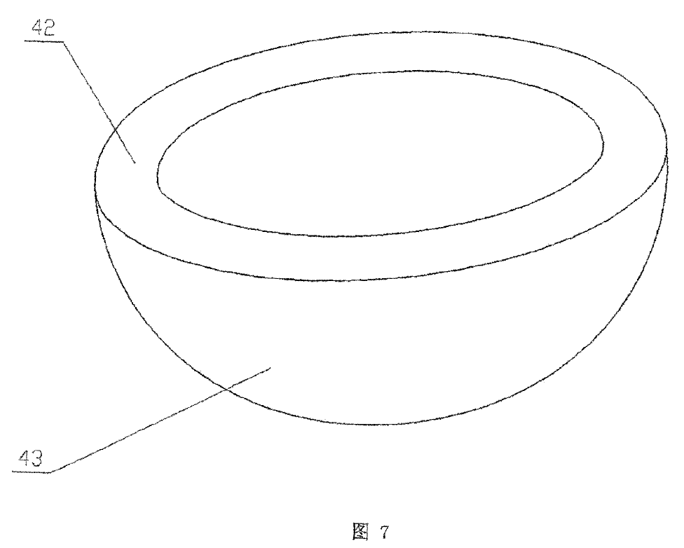

FIGS. 5-6 are the schematic views when the limiting range of the turning-over/stirring device covers the whole range of the cooking container in further another embodiment of the present invention. A pot 39 is connected to its motion platform 33 through a pot loop 40. A driving mechanism 41 of a limiting means 37 drives the limiting means 37 to open and close through a connecting rod 38. FIG. 6 is a view when the limiting means 37 matches intimately with the pot 39 to form a closing pseudo-sphere. An electric motor 34 can drive the pot 39 and the limiting means 37 to make large-angle overturning (up to 180°-360°) through angle gears 35 and 36 to turn over and/or stir the cooking material in the pot. The cooking material will not move out of the pot when the pot turns over, fluctuates and shakes after contacting the limiting means 37 with the pot.

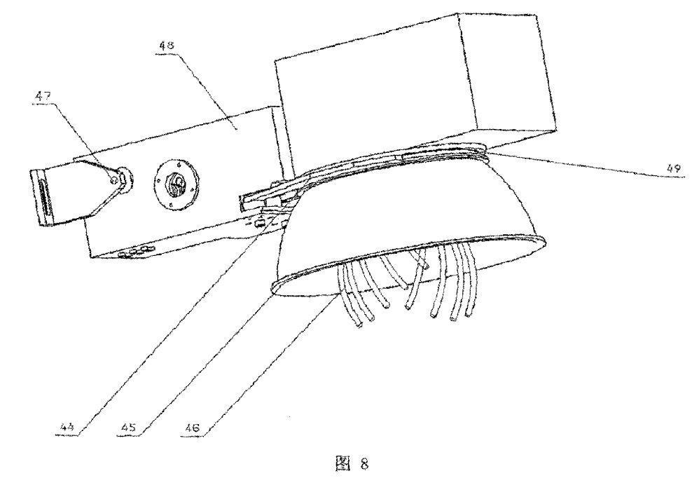

FIG. 7 is the schematic view when the limiting range of the turning-over/stirring device covers the whole range of the cooking container in further another embodiment of the present invention. 42 is a limiting means which is integrated with a pot 43.

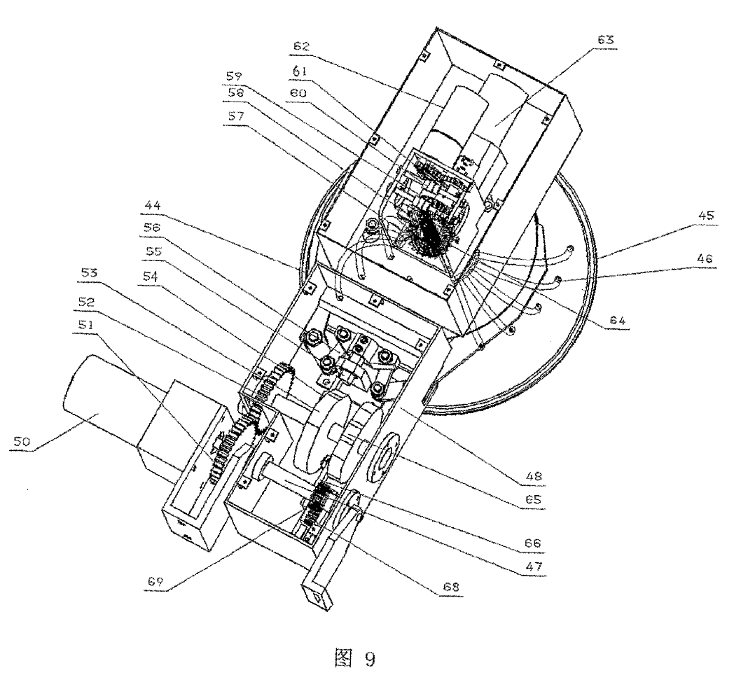

FIGS. 8-9 show still another embodiment of the present invention. 45 is a limiting means. 46 is a pair of dispersing-stirring means which is retractable and can pick and lay. 44 is a clawing manipulator on a swing arm 48 and when closed it can claw the groove portion 49 on the limiting means 45. When a rotation shaft 47 rotates counter-clockwise, it will make the swing arm 48 swing upward to lift the limiting means 45, and when it rotates clockwise, it will make the swing arm 48 swing downward to lower the limiting means 45 and thus make the limiting means contact with the pot. Then the clawing manipulator 44 opens, and the limiting means 45 departs from the swing arm 48 and can move together with the pot. Please refer to FIG. 9. It shows in detail how the device in FIG. 8 operates. An electric motor 50 drives a cam 53 to rotate through gears 51 and 52. The rolling and sliding of an idler wheel 54 in the curved groove of the cam 53 drives a sliding rod 55 to move forward and backward. The forward-backward movement of the sliding rod 55 changes into the opening-closing movement of the clawing manipulator 44 through a connecting rod 56 and thus into its action of catching and laying. Through the gears 51 and 52 the electric motor 50 drives a cam 65 which in turn drives a sliding rod 66 and a connected rack 68 to move forward and backward. Successively, the corresponding turning of the gear 69 joggled with the rack 68 drives a rotation shaft 47 to rotate, which in turn makes the swing arm 48, connected with the rotation shaft 47 to swing upward and downward. An electric motor 63 drives a rotating shaft 58 to rotate through bevel gears 59 and 57, which in turn drives the pair of dispersing-stirring means 46 to perform dispersing-stirring action. An electric motor 62 drives a revolution wheel 61 and draws the connected steel wire to slide on a pulley 60 and thus to draw the rotating shaft 58 to move upward. When moving upward, the rotating shaft 58 makes the pair of dispersing-stirring means 46 to move separately upward to form a horizontal shape through a link mechanism. The electric motor 62 rotates reverse to release the pulling force of the steel wire. A pressing spring 64 causes the pair of dispersing-stirring means 46 to move to its original position to form a vertical S-like shape.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

I claim:

1. An automatic or semi-automatic method for turning over or stirring the cooking material in a cooking container, comprising the following steps:
(1) limiting the cooking material in a cooking container within a desired area of said cooking container in its main directions or all directions by a limiting means, and
(2) turning over or stirring the cooking material limited in said desired area through the movement of said cooking container and/or by a turning-over/stirring means.

2. The method according to claim 1, wherein said method further comprises a step of moving said limiting means to/from a working position.

3. The method according to claim 1, wherein said method further comprises a step of moving said cooking container to/from said limiting means.

4. The method according to claim 1, wherein said method further comprises a step of moving said turning-over/stirring means to/from a working position.

5. The method according to claim 1, wherein said method further comprises a step of moving said cooking container to/from said turning-over/stirring means.

6. A turning-over/stirring device used in an automatic or semi-automatic cooking utensil comprising a cooking container, wherein said turning-over/stirring device further comprises a limiting means, which has a planar and/or curved surface matched with a desired area of said cooking container in size, and is set immovably or movably on the edge of said desired area to prevent the cooking material in said cooking container from moving or being added into an undesired area of said cooking container in its main direction or all directions.

7. The device according to claim 6, wherein said device further comprises a turning-over/stirring means which is a shovel, a ladle, a fork, a stick, a comb, a stirrer with planar or curvy surface, a stirrer which can rotate, make linear movement or make curvilinear movement, a motion mechanism of the cooking container for turning over or stirring the cooking material in it, and the combination thereof.

8. The device according to claim 6 or 7, wherein said limiting means is a cover-like or ring-like object with the shape of its bottom edge being matched with the inner surface of said cooking container.

9. The device according to claim 7, wherein said limiting means and said turning-over/stirring means are installed on a motion mechanism separately or in combination.

10. The device according to claim 9, wherein the connection between said limiting means and said motion mechanism and/or the connection between said turning-over/stirring means and said motion mechanism is a rigid connection, a flexible connection or a detachable connection.

11. The device according to claim 7, wherein said limiting means has one or more holes through one of whose holes said turning-over/stirring means can pass.

12. The device according to claim 6 or 7, wherein said device further comprises a control system which can be independent or be integrated within the main control system of said cooking utensil.

13. An automatic or semi-automatic cooking utensil comprising a cooking container, wherein said cooking utensil has a turning-over/stirring device with a limiting means, in which said limiting means has a planar and/or curved surface matched with a desired area of said cooking container in size, and is set immovably or movably on the edge of said desired area to prevent the cooking material in said cooking container from moving or being added into an undesired area of said cooking container in its main direction or all directions.

14. The cooking utensil according to claim 13, wherein said turning-over/stirring device further comprises a turning-over/stirring means which is a shovel, a ladle, a fork, a stick, a comb, a stirrer with a planar or curvy surface, a stirrer which can rotate, make linear movement or make curvilinear movement, a motion mechanism of the cooking container for turning over or stirring the cooking material in it, and the combination thereof.

15. The cooking utensil according to claim 13 or 15, wherein said limiting means is a cover-like or ring-like object with the shape of its bottom edge being matched with the inner surface of said cooking container.

16. The cooking utensil according to claim 14, wherein said limiting means and said turning-over/stirring means are installed on a motion mechanism separately or in combination.

17. The cooking utensil according to claim 16, wherein the connection between said limiting means and said motion mechanism and/or the connection between said turning-over/stirring means and said motion mechanism is a rigid connection, a flexible connection or a detachable connection.

18. The cooking utensil according to claim 14, wherein said limiting means has one or more holes through one of whose holes said turning-over/stirring means can pass.

19. The cooking utensil according to claim 13 or 14, wherein said cooking utensil further comprises a control system which can be independent or be integrated within the main control system of said cooking utensil.
